(19) United States
(12) Patent Application Publication
(10) Pub. No.: US 2017/0322897 A1
(43) Pub. Date: Nov. 9, 2017

(54) SYSTEMS AND METHODS FOR PROCESSING A SUBMISSION QUEUE

(71) Applicant: Western Digital Technologies, Inc., San Jose, CA (US)

(72) Inventors: SHAY BENISTY, BEER SHEVA (IL); TAL SHARIFIE, LEHAVIM (IL)

(73) Assignee: SANDISK TECHNOLOGIES INC.

(21) Appl. No.: 15/148,409

(22) Filed: May 6, 2016

(51) Int. Cl. G06F 13/37; G06F 12/02; G06F 13/16; G06F 13/42

(52) U.S. Cl. CPC G06F 13/37; G06F 13/4282; G06F 12/023; G06F 13/1621; G06F 2212/1044

(57) ABSTRACT

A data storage device includes a memory and a controller coupled to the memory. The controller is configured to select a submission queue from a set of submission queues of an access device based at least in part on availability of space in a completion queue of the access device.

### FIELD OF THE DISCLOSURE

The present disclosure is generally related to submission queues.

### BACKGROUND

Non-volatile data storage devices, such as universal serial bus (USB) flash memory devices or removable storage cards, have allowed for increased portability of data and software applications. Such non-volatile data storage devices can be attached to or embedded within an access device, such as a host device.

An access device memory of an access device may include queues that track pending commands to be performed by a data storage device and queues that track completed commands to be processed by the access device. For example, the access device memory may include submission queues that track the pending commands and completion queues that track the completed commands. To illustrate, the access device memory may include a first submission queue, a second submission queue, a first completion queue, and a second completion queue. The first submission queue may correspond to the first completion queue. For example, the data storage device may be configured to add a completion queue entry to the first completion queue in response to completing a command indicated by a submission queue entry of the first submission queue. Similarly, the second submission queue may correspond to the second completion queue.

The data storage device may, at various times, determine whether one or more submission queues are non-empty. For example, the data storage device may, in response to detecting an expiration of a timer, determine whether one or more submission queues are non-empty. The data storage device may access a first submission queue entry from the first submission queue and may perform a first command indicated by the first submission queue entry. For example, the first command may include a read operation. The data storage device may perform the read operation in response to accessing the first submission queue entry. The data storage device may, subsequent to performing the first command, add a first completion queue entry to the first completion queue in the access device memory. The access device may determine that the first command has been performed in response to determining that the first completion queue includes the first completion queue entry. For example, the first command may correspond to a read command, the first completion queue entry may indicate a location of data that was read by the data storage device, and the access device may process the first completion queue entry by reading the data from the location. The access device may remove the first completion queue entry from the first completion queue subsequent to processing the first completion queue entry.

In some cases, the first completion queue may be full subsequent to performance of the first command. In these cases, the data storage device may wait to add the first completion queue entry in the first completion queue until the access device processes and removes another completion queue entry from the first completion queue. In these cases, the data storage device may be unable to access additional submission queue entries until space becomes available in the first completion queue for the first completion queue entry. Processing of the second submission queue entry may be delayed until the first completion queue entry is added to the first completion queue, resulting in reduced performance at the data storage device.

### BRIEF DESCRIPTION OF THE DRAWINGS

FIG. 1 is a diagram of a particular illustrative example of a system that includes a data storage device coupled to an access device coupled to or including an access device memory;

FIG. 2 is a diagram of particular illustrative examples of queues that may be processed by the system of FIG. 1;

FIG. 3 is a diagram of particular illustrative examples of queues that may be processed by the system of FIG. 1;

FIG. 4 is a diagram of particular illustrative examples of queues that may be processed by the system of FIG. 1;

FIG. 5 is a diagram of particular illustrative examples of queues that may be processed by the system of FIG. 1;

FIG. 6 is a diagram of particular illustrative examples of queues that may be processed by the system of FIG. 1;

FIG. 7 is a flow chart of a particular illustrative embodiment of a method of processing a submission queue;

FIG. 8A is a block diagram of a particular illustrative embodiment of a non-volatile memory system;

FIG. 8B is a block diagram of a particular illustrative embodiment of a storage module including a plurality of the non-volatile memory systems of FIG. 8A;

FIG. 8C is a block diagram of a particular illustrative embodiment of a hierarchical storage system;

FIG. 9A is a block diagram of components of a particular illustrative embodiment of a controller; and

FIG. 9B is a block diagram of components of a particular illustrative embodiment of a non-volatile memory die.

### DETAILED DESCRIPTION

Particular aspects of the disclosure are described below with reference to the drawings. In the description, common features are designated by common reference numbers. As used herein, “exemplary” may indicate an example, an implementation, and/or an aspect, and should not be construed as limiting or as indicating a preference or a preferred implementation.

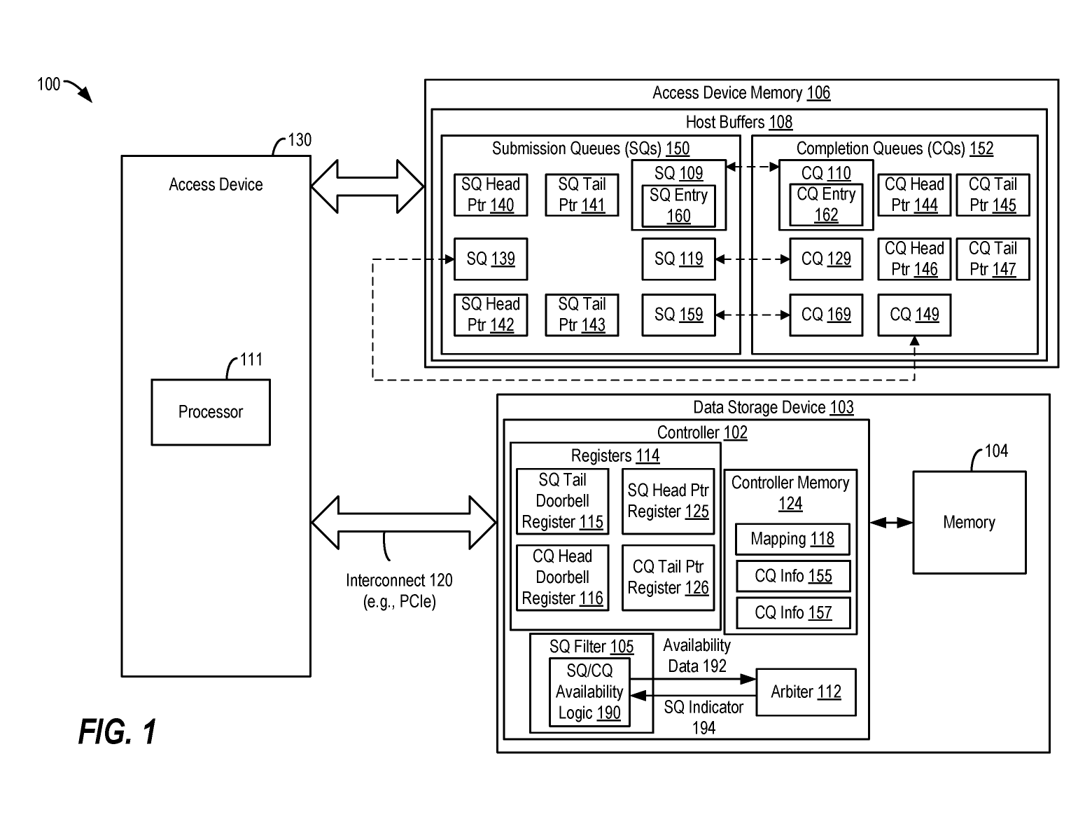

Referring to FIG. 1, a particular embodiment of a system 100 includes a data storage device 103 coupled, via an interconnect 120 (e.g., a peripheral component interconnect (PCIe) bus), to an access device 130. The data storage device 103 includes a memory 104 and a controller 102 coupled to the memory 104. The access device 130 may be configured to provide data to be stored at the memory 104 of the data storage device 103 or to request data to be read from the memory 104. The data storage device 103 may be configured to select a SQ based on availability of space in a corresponding CQ. Selecting the SQ based on availability of space in the corresponding CQ may increase a likelihood that the corresponding CQ will continue to have space to store a CQ entry upon completion of a command from the selected SQ. The data storage device may thus reduce (e.g., eliminate) delay associated with being unable to report the completed command due to the corresponding CQ not having space to store the CQ entry.

The access device 130 may include or may be coupled to an access device memory (e.g., a “memory of the access device”) 106. In a particular aspect, the access device memory 106 may be integrated with the access device 130. The access device memory 106 may store one or more host buffers 108. The one or more host buffers 108 may store one or more submission queues (SQs) 150 and one or more completion queues (CQs) 152. The SQs 150, the CQs 152, or a combination thereof, may correspond to a non-volatile memory express (NVMe) protocol.

The controller 102 is configured to receive data and instructions from and to send data to the access device 130 while the data storage device 103 is operatively coupled to the access device 130. The controller 102 is further configured to send data and commands to the memory 104 and to receive data from the memory 104. For example, the controller 102 is configured to send data and a write command to instruct the memory 104 to store the data to a specified address. As another example, the controller 102 is configured to send a read command to read data from a specified address of the memory 104.

The controller 102 may include a SQ filter 105 and an arbiter 112. The SQ filter 105 may include SQ/CQ availability logic 190. The SQ/CQ availability logic 190 is configured to determine availability data 192 indicating a first subset of the SQs 150 based at least in part on availability of space in the CQs 152, as described herein. The SQ/CQ availability logic 190 may be configured to provide the availability data 192 to the arbiter 112. The arbiter 112 may be configured to select a particular SQ of the first subset based on a selection policy. The selection policy may include a round robin selection policy, a weighted round-robin selection policy, a priority-based selection policy, or a combination thereof. The controller 102 may be configured to perform a particular command corresponding to a submission entry of the particular SQ selected by the arbiter 112. The first subset may indicate SQs that have corresponding CQs that are not full. Selecting the particular SQ from the first subset may increase a likelihood that a corresponding CQ will continue to have space to store a completion queue entry in response to completion of the particular command. Further submission queue processing may thus continue without a delay caused by waiting for space to store the completion queue entry in the corresponding queue.

The controller 102 may include registers 114. The registers 114 may include a SQ tail doorbell register corresponding to each of the SQs 150 and may include a CQ head doorbell register corresponding to each of the CQs 152. For example, the registers 114 may include a SQ tail doorbell register 115 corresponding to the SQ 109 and may include a CQ head doorbell register 116 corresponding to the CQ 110. The access device 130 may be configured to, in response to updating a SQ tail ptr 141 of the SQ 109, update the SQ tail doorbell register 115 to indicate the updated value of the SQ tail ptr 141. The access device 130 may update the SQ tail doorbell register 115 via the interconnect 120. The access device 130 may be configured to, in response to updating a CQ head ptr 144 of the CQ 110, update the CQ head doorbell register 116 to indicate the updated value of the CQ head ptr 144. The access device 130 may update the CQ head doorbell register 116 via the interconnect 120.

The registers 114 may include a SQ head ptr register corresponding to each of the SQs 150 and may include a CQ tail ptr register corresponding to each of the CQs 152. For example, the registers 114 may include a SQ head ptr register 125 corresponding to the SQ 109. The SQ head ptr register 125 may shadow (e.g., track) a SQ head ptr 140 of the SQ 109. The SQ/CQ availability logic 190 may be configured, in response to accessing a SQ entry of the SQ 109, to update the SQ head ptr register 125. The registers 114 may include a CQ tail ptr register 126. The CQ tail ptr register 126 may shadow the CQ tail ptr 145. The SQ/CQ availability logic 190 may be configured, in response to adding one or more CQ entries to the CQ 110, to update the CQ tail ptr register 126, to send an interrupt via the interconnect 120 to the access device 130, or both. The processor 111 may be configured to, in response to receiving the interrupt, update the CQ tail ptr 145 based on the one or more CQ entries. The processor 111 may be configured to update the SQ head ptr 140 based on the one or more CQ entries. For example, the one or more CQ entries may indicate one or more corresponding SQ entries. The processor 111 may, in response to determining that the one or more CQ entries have been added to the CQ 110, determine that the one or more corresponding SQ entries have been accessed by the data storage device 103 from the SQ 109. The processor 111 may update the SQ head ptr 140 to indicate that the one or more corresponding SQ entries have been accessed.

The controller 102 may include controller memory 124. The controller memory 124 may include mapping data 118. The mapping data 118 may indicate a mapping between a SQ and a CQ, as described herein.

The access device 130 may include a processor 111. The access device 130 may include a mobile telephone, a music player, a video player, a gaming console, an electronic book reader, a personal digital assistant (PDA), a computer, such as a laptop computer or notebook computer, any other electronic device, or any combination thereof.

The controller 102 may include an interface (not shown) that enables the access device 130 to communicate with the data storage device 103 (e.g., including the memory 104) via the interconnect 120. Among other things, the interconnect 120 enables the access device 130 to read from the memory 104 and to write to the memory 104. For example, the access device 130 may operate in compliance with a Joint Electron Devices Engineering Council (JEDEC) industry specification, such as a Universal Flash Storage (UFS) Host Controller Interface specification. As another example, the access device 130 may operate in compliance with one or more other specifications, such as a Secure Digital (SD) Host Controller specification as an illustrative example. The access device 130 may communicate with the memory 104 in accordance with any other suitable communication protocol.

The memory 104 may be a non-volatile memory, such as a NAND flash memory. For example, the data storage device 103 may be a memory card, such as a Secure Digital SD® card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). As another example, the data storage device 103 may be configured to be coupled to the access device 130 as embedded memory, such as eMMC® (trademark of JEDEC Solid State Technology Association, Arlington, Va.) and eSD, as illustrative examples. To illustrate, the data storage device 103 may correspond to an eMMC (embedded MultiMedia Card) device. The data storage device 103 may operate in compliance with a JEDEC industry specification. For example, the data storage device 103 may operate in compliance with a JEDEC eMMC specification, a JEDEC Universal Flash Storage (UFS) specification, one or more other specifications, or a combination thereof.

The SQs 150 may include a submission queue (SQ) 109, a SQ 119, a SQ 139, a SQ 159, or a combination thereof. The CQs 152 may include a completion queue (CQ) 110, a CQ 129, a CQ 149, a CQ 169, or a combination thereof. A particular SQ may correspond to a particular CQ. For example, the SQ 109 may correspond to the CQ 110, the SQ 119 may correspond to the CQ 129, the SQ 139 may correspond to the CQ 149, the SQ 159 may correspond to the CQ 169, or a combination thereof. In a particular aspect, multiple SQs may correspond to a single CQ. For example, the SQ 109 and another SQ of the SQs 150 may correspond to the CQ 110.

A particular submission queue may correspond to a circular buffer with a fixed slot size that the access device 130 uses to submit commands for execution by the controller 102. The particular submission queue may include a particular number of portions (e.g., slots). Each portion (or slot) of the particular submission queue may have a fixed slot size. A portion (or slot) of the particular submission queue may be used to store a submission queue entry. The particular submission queue may include the SQ 109, the SQ 119, the SQ 139, the SQ 159, or a combination thereof.

A particular completion queue may correspond to a circular buffer with a fixed slot size used by the controller 102 to post status for completed commands. The particular completion queue may include a particular number of portions (e.g., slots). Each portion (or slot) of the particular completion queue may have a fixed slot size. A portion (or slot) of the particular completion queue may be used to store a completion queue entry. The particular completion queue may include the CQ 110, the CQ 129, the CQ 149, the CQ 169, or a combination thereof.

A particular queue may operate in conjunction with a corresponding head pointer (ptr) and a corresponding tail ptr. The particular queue may include the SQ 109, the SQ 119, the SQ 139, the SQ 159, the CQ 110, the CQ 129, the CQ 149, or the CQ 169. For example, the SQ 109 may have the SQ head ptr 140 and the SQ tail ptr 141, the SQ 159 may have a SQ head ptr 142 and a SQ tail ptr 143, the CQ 110 may have the CQ head ptr 144 and a CQ tail ptr 145, the CQ 129 may have a CQ head ptr 146 and a CQ tail ptr 147, or a combination thereof. Similarly, each of the SQ 119, the SQ 139, the CQ 149, the CQ 169, or a combination thereof, may have a corresponding head ptr and a corresponding tail ptr. In a particular aspect, the access device 130 may store a head ptr, a tail ptr, or both, in the access device memory 106. In a particular aspect, the access device 130 may store a head ptr, a tail ptr, or both, outside the access device memory 106. For example, the access device 130 may store a head ptr, a tail ptr, or both, in one or more registers of the access device 130. In a particular aspect, a head ptr, a tail ptr, or both, may be implemented in firmware code that is executed by the processor 111.

A head ptr may indicate a first slot (e.g., location) of a corresponding queue and a tail ptr may indicate a second slot of the corresponding queue. For example, the SQ head ptr 140 may indicate a first SQ slot of the SQ 109 and the SQ tail ptr 141 may indicate a second SQ slot of the SQ 109. The head ptr may have the same value as the tail ptr when the corresponding queue is empty. For example, the first SQ slot may be the same as the second SQ slot. When the corresponding queue is non-empty, the head ptr may indicate a slot (e.g., a head slot) of a next queue entry to be processed from the corresponding queue and the tail ptr may indicate a slot (e.g., a tail slot) that is empty and is logically after the head slot in the corresponding queue. In a particular aspect, the corresponding queue may include multiple empty slots and the tail slot may correspond to an initial empty slot of the multiple empty slots that is logically subsequent to the head slot. For example, when the corresponding queue is not full, the tail ptr may indicate a slot where a next queue entry, if any, is to be added. The corresponding queue may correspond to a circular buffer in that an initial slot of the corresponding queue may be logically next to and logically after a last slot of the corresponding queue.

The head ptr may indicate a queue entry that was added earliest to the corresponding queue. The tail ptr may indicate a next available slot, if any, of the corresponding queue. For example, the access device 130 may, in response to determining that a SQ is not full, add a SQ entry to the SQ at a slot indicated by a tail ptr of the SQ and update the tail ptr. The data storage device 103 may access a SQ entry corresponding to a head ptr of the SQ and update the head ptr. The data storage device 103 may access SQ entries from the SQ in the same order that the access device 130 adds the SQ entries to the SQ. As another example, the data storage device 103 may, in response to determining that a CQ is not full, add a CQ entry to the CQ at a slot indicated by a tail ptr of the CQ and update the tail ptr. The access device 130 may access a CQ entry corresponding to a head ptr of the CQ and update the head ptr. The access device 130 may access CQ entries from the CQ in the same order that the data storage device 103 adds the CQ entries to the CQ. Accessing a SQ entry from a SQ based at least in part on determining that a corresponding CQ has space available to store a corresponding CQ entry may reduce delays associated with the corresponding CQ being full and not having space to store the corresponding CQ entry upon completion of a command indicated by the SQ entry.

During an initialization phase, the processor 111 of the access device 130 may generate the SQs 150, the CQs 152, or both. For example, the processor 111 may determine configuration data indicating a first number of SQs supported by the data storage device 103, a second number of CQs supported by the data storage device 103, or both. In a particular aspect, the access device 130 may receive the configuration data from the data storage device 103. The processor 111 may initialize the SQs 150, the CQs 152, or both, based on the configuration data. For example, the processor 111 may allocate memory in the host buffers 108 corresponding to each of the SQs 150, the CQs 152, or both. The processor 111 may initialize a head ptr and a tail ptr corresponding to each of the SQs 150, the CQs 152, or both. A head ptr may be initialized to indicate the same value as a corresponding tail ptr. For example, the processor 111 may initialize the SQ head ptr 140 to indicate the same slot of the SQ 109 as indicated by the SQ tail ptr 141. The access device 130 may initialize, via the interconnect 120, one or more of the registers 114. For example, the access device 130 may initialize the SQ tail doorbell register 115 to indicate the same value as the SQ tail ptr 141, the SQ head ptr register 125 to indicate the same value as the SQ head ptr 140, the CQ head doorbell register 116 to indicate the same value as the CQ head ptr 144, the CQ tail ptr register 126 to indicate the same value as the CQ tail ptr 145, or a combination thereof.

The processor 111 may generate the mapping data 118 indicating a mapping between the SQs 150 and the CQs 152. For example, the mapping data 118 may indicate that the SQ 109 corresponds to the CQ 110, the SQ 119 corresponds to the CQ 129, the SQ 139 corresponds to the CQ 149, the SQ 159 corresponds to the CQ 169, or a combination thereof. The access device 130 may provide the mapping data 118, via the interconnect 120, to the data storage device 103.

The controller 102 may store the mapping data 118 in the controller memory 124. The SQ/CQ availability logic 190 may maintain CQ information (info) corresponding to each CQ. For example, the SQ/CQ availability logic 190 may maintain CQ info 155 corresponding to the CQ 110, CQ info 157 corresponding to the CQ 129, or both. The SQ/CQ availability logic 190 may similarly maintain CQ info corresponding to the CQ 149, CQ info corresponding to CQ 169, or both. The SQ/CQ availability logic 190 may initialize CQ info of a corresponding CQ to indicate the same value as CQ tail ptr of the corresponding CQ. For example, the SQ/CQ availability logic 190 may initialize the CQ info 155 to indicate the same value as indicated by the CQ tail ptr 145 (or the CQ tail ptr register 126). As another example, the SQ/CQ availability logic 190 may initialize the CQ info 157 to indicate the same value as indicated by the CQ tail ptr 147. In a particular aspect, the SQ/CQ availability logic 190 may initialize the CQ info 157 to indicate the same value as a CQ tail ptr register of the registers 114 corresponding to the CQ tail ptr 147.

During a SQ update phase, the access device 130 may determine that a particular command is to be performed by the data storage device 103. The particular command may include a read command, a write command, or another command. The access device 130 may generate a SQ entry 160 indicating the particular command. The access device 130 may add the SQ entry 160 to the SQ 109. In a particular aspect, the particular command may correspond to a particular application. The access device 130 may add the SQ entry 160 to the SQ 109 in response to determining that the SQ 109 corresponds to the particular application. The access device 130 may update the SQ tail ptr 141 in response to adding the SQ entry 160 to the SQ 109. In a particular aspect, the access device 130 may update the SQ tail ptr 141 in response to adding multiple SQ entries to the SQ 109. The access device 130 may update, via the interconnect 120, the SQ tail doorbell register 115 to indicate the updated value of the SQ tail ptr 141. An update of the SQ tail doorbell register 115 may indicate to the SQ/CQ availability logic 190 that at least one entry has been added to the SQ 109.

During a command execution phase, the SQ/CQ availability logic 190 may generate the availability data 192. For example, the SQ/CQ availability logic 190 may generate the availability data 192, as described herein, in response to detecting an update of the SQ tail doorbell register 115 by the access device 130, an update of the CQ head doorbell register 116 by the access device 130, an expiration of a timer, completion of a command, one or more other events, or a combination thereof.

The SQ/CQ availability logic 190 may determine that a first set of the SQs 150 includes at least one non-empty SQ. For example, the SQ/CQ availability logic 190 may determine that the first set includes the SQ 109 in response to determining that the SQ 109 is non-empty. In a particular aspect, the SQ/CQ availability logic 190 may determine that the SQ 109 is non-empty in response to determining that a value of the SQ head ptr register 125 is distinct from a value of the SQ tail doorbell register 115. The SQ/CQ availability logic 190 may similarly determine that the first set includes the SQ 119 in response to determining that the SQ 119 is non-empty, that the first set includes the SQ 139 in response to determining that the SQ 139 is non-empty, that the first set includes the SQ 159 in response to determining that the SQ 159 is non-empty, or a combination thereof. As referred to herein, a “ptr value” of a queue may refer to a value of a ptr of the queue. For example, a SQ head ptr value of the SQ 109 may correspond to a value of the SQ head ptr 140 (or the SQ head ptr register 125), and a SQ tail ptr value of the SQ 109 may correspond to a value of the SQ tail ptr 141 (or the SQ tail doorbell register 115).

The SQ/CQ availability logic 190 may determine that the SQ 159 is not included in the first set in response to determining that the SQ 159 is empty. In a particular aspect, the SQ/CQ availability logic 190 may determine that the SQ 159 is empty in response to determining that a value of the SQ head ptr 142 (or a SQ head ptr register associated with the SQ head ptr 142) is the same as a value of the SQ tail ptr 143 (or a SQ tail doorbell register associated with the SQ tail ptr 143). In this example, the first set includes the SQ 109, the SQ 119, the SQ 139, or a combination thereof, and the SQ 159 is not included in the first set.

The SQ/CQ availability logic 190 may select a first subset of the first set based on availability of space in corresponding CQs of the CQs 152. For example, each SQ of the first subset corresponds to a CQ that is not full so that there is space available in the CQ to add a CQ entry. The SQ/CQ availability logic 190 may determine that the first subset includes the SQ 109 in response to determining, based on the CQ info 155, that the CQ 110 is not full. The CQ info 155 may indicate availability of space in the CQ 110. For example, the SQ/CQ availability logic 190 may update the CQ info 155, in response to accessing a SQ entry from the SQ 109, to indicate that one less slot of the CQ 110 is available or that one more slot of the CQ 110 is unavailable, as described herein. The SQ/CQ availability logic 190 may update the SQ head ptr register 125 in response to accessing the SQ entry from the SQ 109.

The SQ/CQ availability logic 190 may update the CQ info 155, the CQ tail ptr register 126, or both, in response to adding a CQ entry to the CQ 110, to indicate that one less slot of the CQ 110 is available or that one more slot of the CQ 110 is unavailable, as described herein. The SQ/CQ availability logic 190 may update the CQ info 155, the CQ tail ptr register 126, or both, in response to accessing a CQ entry from the CQ 110 to indicate that one more slot of the CQ 110 is available or that one fewer slot of the CQ 110 is unavailable, as described herein.

The SQ/CQ availability logic 190 may determine that the CQ 110 is not full in response to determining that the CQ info 155 indicates that at least one slot of the CQ 110 is available, that fewer than all slots of the CQ 110 are unavailable, or both. Determining whether one or more slots are “available” may be based on how many slots contain an entry and how many slots have been “reserved” for an entry, as explained in further detail below.

In a particular aspect, the CQ info 155 may indicate a CQ tail ptr value. The SQ/CQ availability logic 190 may determine that the CQ 110 is not full (e.g., has available space) in response to determining that the CQ head ptr 146 indicates a slot of the CQ 110 that is not logically next to and logically after a first CQ slot indicated by the CQ tail ptr value. In a particular aspect, the SQ/CQ availability logic 190 may determine a next CQ tail ptr value based on the CQ tail ptr value indicated by the CQ info 155. For example, the CQ tail ptr value may indicate a first CQ slot of the CQ 110. The SQ/CQ availability logic 190 may determine the next CQ tail ptr value that indicates a second CQ slot that is logically next to and logically after the first CQ slot. The SQ/CQ availability logic 190 may determine that the CQ 110 has available space (e.g., is not full) in response to determining that the next CQ tail ptr value is distinct from a value of the CQ head ptr 146 (or the CQ head doorbell register 116). The SQ/CQ availability logic 190 may similarly determine that the first subset includes the SQ 139 in response to determining that the CQ 149 is not full.

The SQ/CQ availability logic 190 may determine that the SQ 119 is not to be included in the first subset in response to determining that the CQ 129 is full. For example, the SQ/CQ availability logic 190 may determine that the CQ 129 is full (e.g., has no available space) in response to determining that the CQ info 157 indicates that no slots of the CQ 129 are available, that all slots of the CQ 129 are unavailable, or both. In a particular aspect, the CQ info 157 may indicate a CQ tail ptr value of the CQ 129. The SQ/CQ availability logic 190 may determine that the CQ 129 is full in response to determining that the CQ head ptr 146 (or a CQ head doorbell register of the registers 114 associated with the CQ head ptr 146) indicates a slot of the CQ 129 that is logically after and logically next to a first CQ slot of the CQ 129 indicated by the CQ tail ptr value. In this example, the first subset may include the SQ 109 and the SQ 139, but not the SQ 119.

In a particular aspect, the SQ/CQ availability logic 190 may generate the first subset by masking out the SQs from the first set that correspond to a full CQ. For example, the SQ/CQ availability logic 190 may generate the first subset by masking out the SQ 119 from the SQ 109, the SQ 119, the SQ 139, or a combination thereof, of the first set. For example, the first subset may include the SQ 109, the SQ 139, or both.

The SQ/CQ availability logic 190 may generate the availability data 192 indicating the first subset. For example, the availability data 192 may indicate the SQ 109, the SQ 139, or both. The SQ/CQ availability logic 190 may provide the availability data 192 to the arbiter 112.

The arbiter 112 may select a particular SQ from the first subset based on a selection policy. For example, the arbiter 112 may select the SQ 109 from the SQ 109, the SQ 139, or both, based on a selection policy. The selection policy may include a round robin selection policy, a weighted round robin selection policy, a priority-based selection policy, one or more other selection policies, or a combination thereof. The arbiter 112 may generate a SQ indicator 194 that indicates the selected SQ. For example, the SQ indicator 194 may indicate the SQ 109. The arbiter may provide the SQ indicator 194 to the SQ/CQ availability logic 190.

The SQ/CQ availability logic 190 may access a particular SQ entry of the SQ indicated by the SQ indicator 194. The particular SQ entry may be indicated by a head ptr of the particular SQ. For example, the SQ/CQ availability logic 190 may access a particular SQ entry of the SQ 109 in response to determining that the SQ indicator 194 indicates the SQ 109, and that the SQ head ptr 140 (or the SQ head ptr register 125) indicates the particular SQ entry. The particular SQ entry may include the SQ entry 160. The SQ/CQ availability logic 190 may, in response to accessing the SQ entry 160, update (e.g., increment) the SQ head ptr register 125.

The SQ/CQ availability logic 190 may, in response to accessing the SQ entry 160, update the CQ info 155 to indicate that a slot of the CQ 110 is unavailable. For example, in response to accessing the SQ entry 160, a slot of the CQ 110 may be reserved for storing a CQ entry corresponding to the SQ entry 160. To illustrate, the CQ info 155 may be updated to indicate that one fewer slot of the CQ 110 is available, that one more slot of the CQ 110 is unavailable, or both. A slot of the CQ 110 may be unavailable if the slot includes a CQ entry or if the slot is reserved for an expected CQ entry. In a particular aspect, the CQ info 155 may indicate a CQ tail ptr value corresponding to a first CQ slot of the CQ 110. The SQ/CQ availability logic 190 may, in response to accessing the SQ entry 160, update the CQ tail ptr value indicated by the CQ info 155 to correspond to a second CQ slot of the CQ 110. The second CQ slot may be logically next to and logically after the first CQ slot.

The controller 102 may perform the particular command indicated by the SQ entry 160. For example, the SQ entry 160 may indicate that data from a particular location of the memory 104 is to be read. The controller 102 may read data from the particular location. The SQ/CQ availability logic 190 may generate a CQ entry 162 in response to determining that the particular command has been performed. The CQ entry 162 may indicate the SQ entry 160, the SQ 109, or both. The CQ entry 162 may indicate a value of the SQ head ptr register 125. The CQ entry 162 may indicate information corresponding to the particular command. For example, the CQ entry 162 may indicate a status flag, an error flag, or both, corresponding to reading the data from the particular location of the memory 104. The SQ/CQ availability logic 190 may add the CQ entry 162 to the CQ 110. The SQ/CQ availability logic 190 may, in response to adding the CQ entry 162 to the CQ 110, update (e.g., increment) the CQ tail ptr register 126, send an interrupt via the interconnect 120 to the access device 130, or both. The processor 111 may, in response to receiving the interrupt, update the CQ tail ptr 145 based on the CQ entry 162. For example, the processor 111 may, in response to determining that a field of the CQ entry 162 has a first value (e.g., 1), determine that the CQ entry 162 is newly added to the CQ 110. The processor 111 may, in response to determining that the CQ entry 162 is newly added to the CQ 110, update the CQ tail ptr 145 to indicate a next slot of the CQ 110, update the field of the CQ entry 162 to have a second value (e.g., 0), or both.

During a CQ entry processing phase, the processor 111 may access a particular CQ entry of the CQ 110 in response to determining that the particular CQ entry is indicated by the CQ head ptr 144. The particular CQ entry may include the CQ entry 162. The processor 111 may process the CQ entry 162. For example, the CQ entry 162 may indicate a status flag, an error flag, or both, corresponding to reading data from the memory 104. The processor 111 may process the data based on the status flag, the error flag, or both. The CQ entry 162 may indicate a value of the SQ head ptr register 125. The processor 111 may determine that the CQ entry 162 is associated with the SQ 109 in response to determining that the CQ entry 162 indicates the SQ 109, the SQ entry 160, or both. The processor 111 may, in response to determining that the CQ entry 162 is associated with the SQ 109, update the SQ head ptr 140 based on the value of the SQ head ptr register 125 indicated by the CQ entry 162. The processor 111 may, in response to determining that the CQ entry 162 has been processed, update (e.g., increment) the CQ head ptr 144. The processor 111 may update the CQ head doorbell register 116 to indicate the updated CQ head ptr 144. An update of the CQ head doorbell register 116 may indicate to the SQ/CQ availability logic 190 that one more slot of the CQ 110 is available, that one fewer slot of the CQ 110 is unavailable, or both. In a particular aspect, the SQ/CQ availability logic 190 may select a next SQ entry to process in response to detecting the update of the CQ head doorbell register 116. In a particular aspect, the SQ/CQ availability logic 190 may update the CQ info 155 and use the updated CQ info 155 to select a next SQ entry to process in response to detecting the update of the CQ head doorbell register 116.

The system 100 may thus enable access of a SQ based on availability of space in a corresponding CQ. The SQ/CQ availability logic 190 may, based on the CQ info 155, determine whether the CQ 110 is full based on reserved slots, in addition to slots that are in use, prior to accessing the SQ 109. The SQ/CQ availability logic 190 may thus access a SQ entry of the SQ 109 when there is going to be space available in the CQ 110 to store a corresponding CQ entry. The SQ/CQ availability logic 190 may mask the SQ 109 (e.g., not include the SQ 109 in the availability data 192) such that the SQ 109 is not accessed when there is not going to be space available in the CQ 110 to store the corresponding CQ entry. A likelihood of SQ processing to be blocked by generating a CQ entry for which there is no space in a corresponding CQ may be reduced.

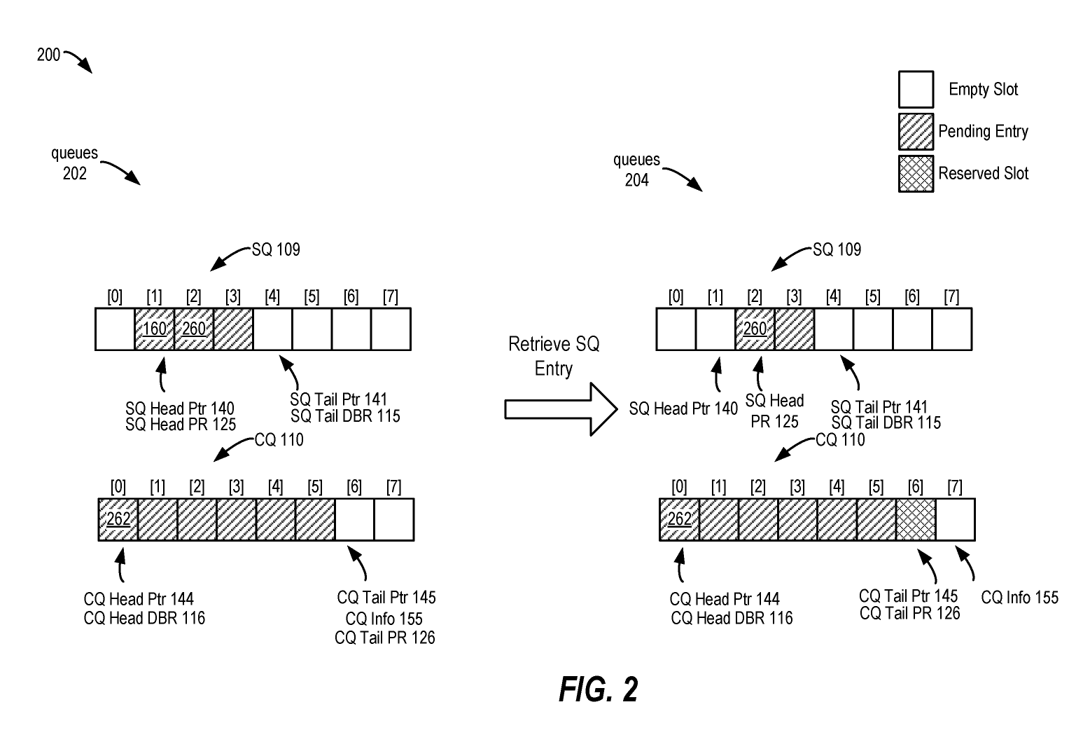

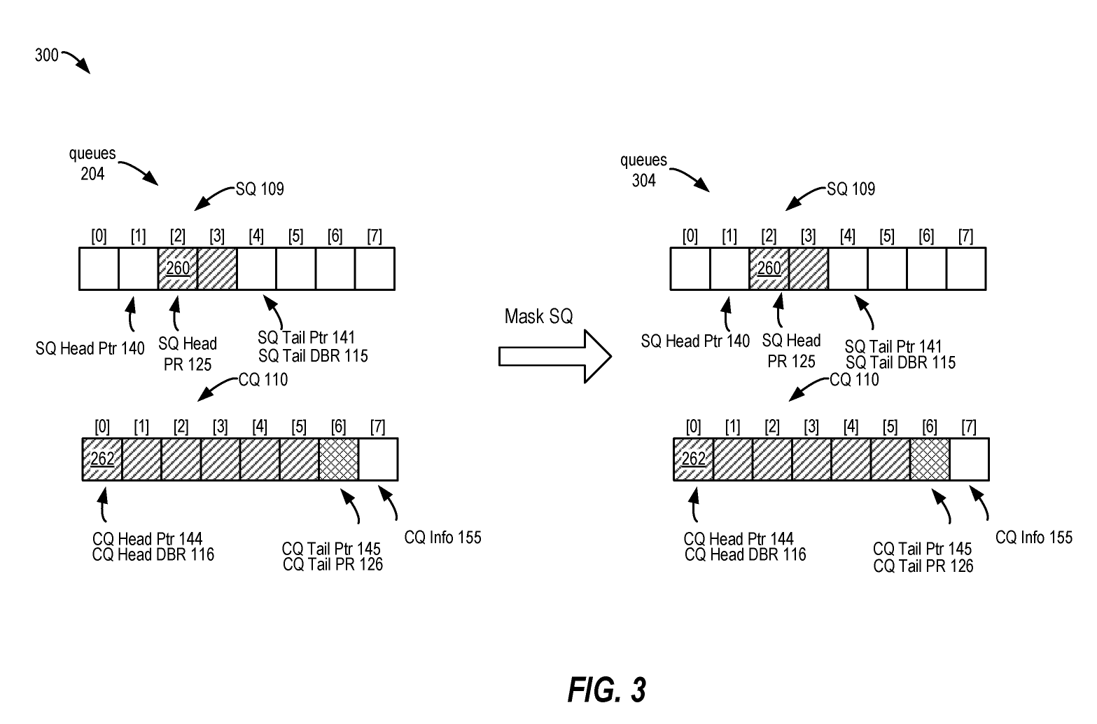

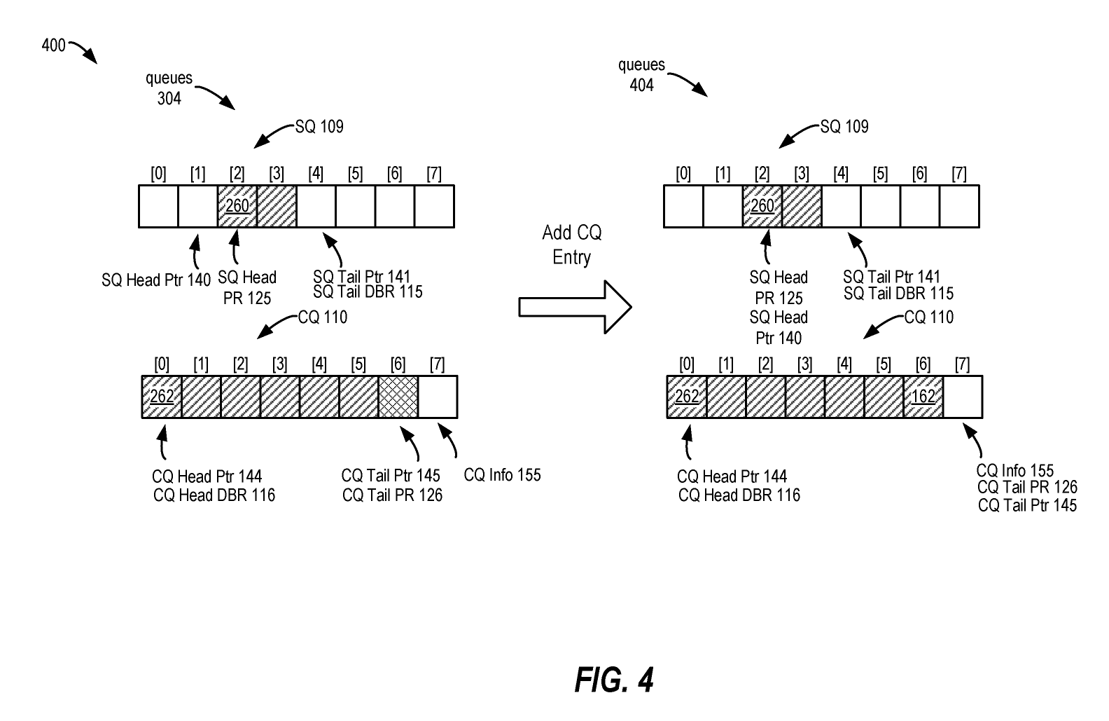

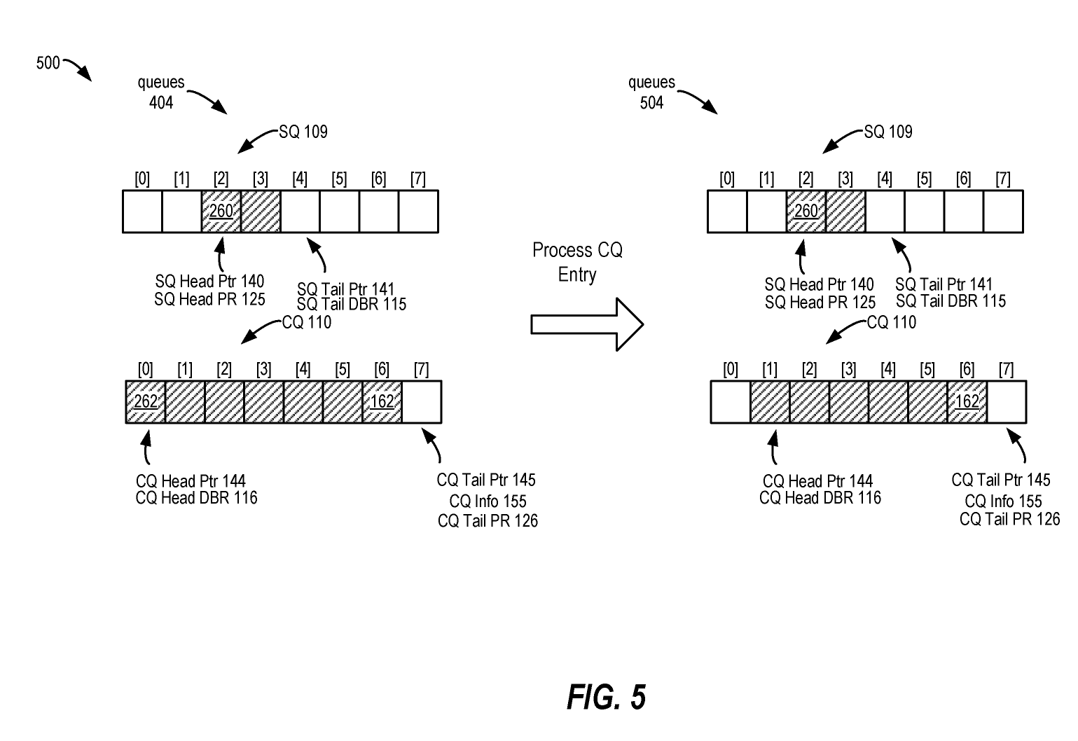

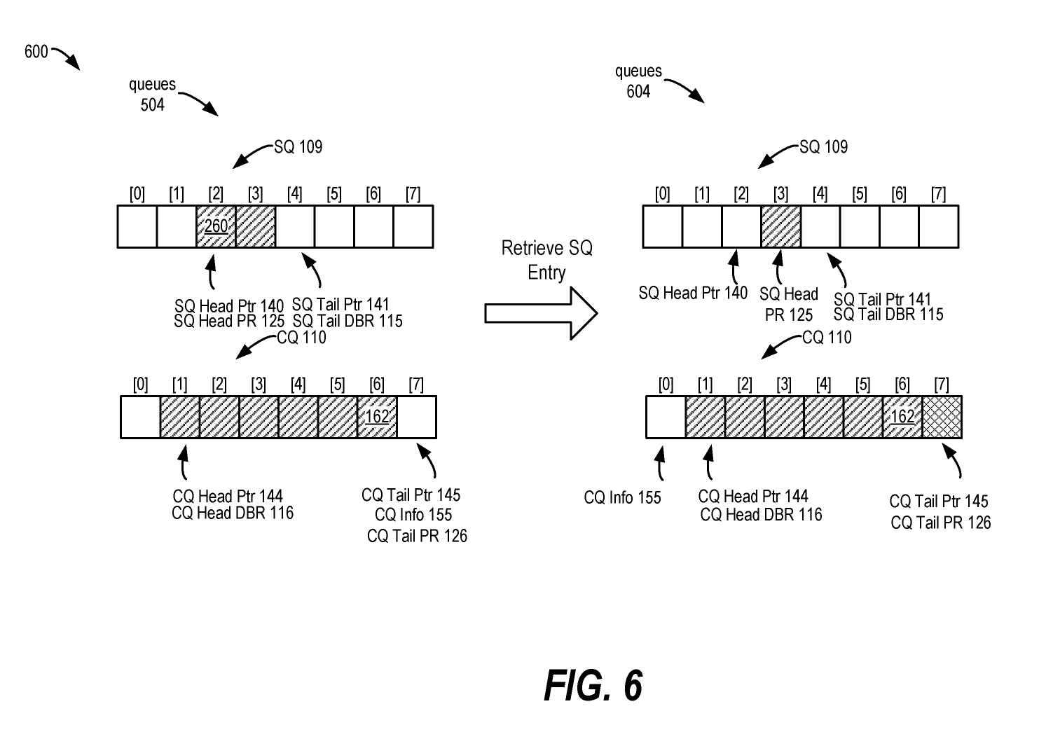

FIGS. 2-6 illustrate examples of queues that may be processed by the system 100 of FIG. 1. FIG. 2 illustrates an example of processing a non-empty submission queue when a corresponding completion queue is not full. FIG. 3 illustrates an example of processing a non-empty submission queue when a corresponding completion queue is full and includes at least one reserved slot. FIG. 4 illustrates an example of adding a completion queue entry to a reserved slot of a completion queue. FIG. 5 illustrates an example of processing a completion queue entry. FIG. 6 illustrates an example of processing a non-empty submission queue when the corresponding completion queue is not full.

A slot of a queue illustrated in one or more of FIGS. 2-6 with diagonal lines may include an existing queue entry (e.g., valid data). A slot of a completion queue illustrated in one or more of FIGS. 2-6 with cross-hatching may correspond to a reserved slot. A slot of a queue illustrated in one or more of FIGS. 2-6 with an empty square may correspond to an empty slot. An empty slot may include invalid data.

A queue head ptr may indicate a head slot of a corresponding queue. A queue tail pointer may indicate a slot of the corresponding queue that is logically next to and logically after a particular slot that includes a most recently added queue entry. The queue may include an end slot that corresponds to a last slot of the queue logically prior to the head slot. For example, the queue may be circular and the head slot may be logically next to and logically after the end slot. The end slot may be unavailable to store a queue entry, as described herein. If a queue entry is added to the end slot, the queue tail ptr would be updated to indicate a slot (e.g., the head slot) that is logically after and logically next to the end slot. A value of the queue tail ptr would be the same as a value of the queue head ptr, thereby indicating that the corresponding queue is empty. To prevent the queue tail ptr and the queue head ptr from indicating that the corresponding queue is empty when the corresponding queue is full, the end slot may be unavailable to store a queue entry. As referred to herein, a “full queue” may correspond to a queue without available slots. For example, a full queue may include an empty slot (e.g., the end slot) that is unavailable.

Referring to FIG. 2, a diagram is shown and generally designated 200. The diagram 200 includes queues 202 and queues 204. The queues 202 may indicate the SQ 109 and the CQ 110 at a first time. The queues 204 may indicate the SQ 109 and the CQ 110 at a second time. The second time may be subsequent to the first time.

At the first time, the SQ 109 may be non-empty. The SQ head ptr 140 and the SQ head ptr register (PR) 125 may indicate a first SQ slot of the SQ 109. The SQ tail ptr 141 and the SQ tail doorbell register (DBR) 115 may indicate a second SQ slot of the SQ 109, and the first SQ slot may be distinct from the second SQ slot. For example, the SQ head ptr 140 may indicate a first SQ index (e.g., 1) corresponding to the first SQ slot, and the SQ tail ptr 141 may indicate a second SQ index (e.g., 4) corresponding to the second SQ slot. The SQ 109 may include the SQ entry 160 at the first SQ slot. The SQ 109 may include a SQ entry 260 at a particular SQ slot corresponding to a particular SQ index (e.g., 2). As illustrated, the particular SQ slot is logically next to and logically after the first SQ slot.

At the first time, the CQ 110 may be not full. For example, the CQ 110 may include at least one slot that is available to store a CQ entry. The CQ head ptr 144 and the CQ head DBR 116 may indicate a first CQ slot of the CQ 110 corresponding to a first CQ index (e.g., 0). The CQ 110 may include a CQ entry 262 at the first CQ slot. The CQ tail ptr 145 and the CQ tail PR 126 may indicate a second CQ slot of the CQ 110 corresponding to a second CQ index (e.g., 6). The CQ info 155 may also indicate the second CQ slot. The CQ info 155 may indicate the same slot as the CQ tail PR 126 when no reserved slots are included in the CQ 110.

During operation, the SQ/CQ availability logic 190 may determine that the SQ 109 is non-empty, as described with reference to FIG. 1. For example, the SQ/CQ availability logic 190 may determine that the SQ 109 is non-empty in response to determining that the first SQ index (e.g., 1) indicated by the SQ head PR 125 is distinct from the second SQ index (e.g., 4) indicated by the SQ tail DBR 115.

The SQ/CQ availability logic 190 may determine that the CQ 110 is not full in response to determining that the CQ 110 includes at least one available slot based on the CQ info 155 and the CQ head DBR 116, as described with reference to FIG. 1. For example, the CQ info 155 may indicate the second CQ slot of the CQ 110 corresponding to the second CQ index (e.g., 6). The SQ/CQ availability logic 190 may generate a next queue tail ptr indicating a particular CQ slot that is logically next to and logically after the second CQ slot. The particular CQ slot may correspond to a particular CQ index (e.g., 7). The SQ/CQ availability logic 190 may determine that the CQ 110 is not full in response to determining that a value (e.g., 7) of the next queue tail ptr is distinct from a value (e.g., 0) of the CQ head DBR 116.

The SQ/CQ availability logic 190 may, in response to determining that the SQ 109 is non-empty and that the CQ 110 is not full, generate the availability data 192 of FIG. 1 to indicate the SQ 109. The arbiter 112 may select the SQ 109 based on a selection policy, as described with reference to FIG. 1. For example, the arbiter 112 may provide the SQ indicator 194 of FIG. 1 to the SQ/CQ availability logic 190. The SQ indicator 194 may indicate the SQ 109.

The SQ/CQ availability logic 190 may, in response to determining that the SQ indicator 194 indicates the SQ 109, access the SQ entry 160 from the first SQ slot corresponding to the first index (e.g., 1) indicated by the SQ head PR 125. The SQ/CQ availability logic 190 may, in response to accessing the SQ entry 160, update (e.g., increment) the SQ head PR 125 to indicate the second SQ slot of the SQ 109 corresponding to the second index (e.g., 2).

The SQ/CQ availability logic 190 may, in response to accessing the SQ entry 160, update the CQ info 155, to indicate that a slot of the CQ 110 is reserved to store a CQ entry corresponding to the SQ entry 160, as described with reference to FIG. 1. For example, the SQ/CQ availability logic 190 may update (e.g., increment) the CQ info 155 to indicate a particular CQ slot of the CQ 110 corresponding to a particular CQ index (e.g., 7). The particular CQ slot may be logically next to and logically after the second CQ slot. The queues 204 may indicate the SQ 109 and the CQ 110 subsequent to the update of the SQ head PR 125 and the CQ info 155.

Thus, a CQ slot of the CQ 110 may be reserved to store a CQ entry corresponding to a SQ entry (e.g., the SQ entry 160) that has been accessed by the SQ/CQ availability logic 190. In a particular aspect, the CQ 110 may include multiple reserved slots. For example, a first slot of the CQ 110 may be reserved in response to accessing a first SQ entry of the SQ 109 and a second slot of the CQ 110 may be reserved in response to accessing a second SQ entry of the SQ 109.

In a particular aspect, the SQ/CQ availability logic 190 may, in response to determining that the SQ indicator 194 indicates the SQ 109, access multiple entries from the SQ 109 and reserve multiple slots of the CQ 110. For example, at a first iteration, the SQ/CQ availability logic 190 may, in response to determining the SQ 109 is non-empty and the CQ 110 is not full, access an entry of the SQ 109, update the SQ head PR 125, and update the CQ info 155 to reserve a slot of the CQ 110. At a subsequent iteration, the SQ/CQ availability logic 190 may, in response to determining the SQ 109 is non-empty and the CQ 110 is not full, access another entry of the SQ 109, update the SQ head PR 125, and update the CQ info 155 to reserve another slot of the CQ 110. The SQ/CQ availability logic 190 may perform multiple iterations until determining that the SQ 109 is empty or that the CQ 110 is full.

Referring to FIG. 3, a diagram is shown and generally designated 300. The diagram 300 includes the queues 204 and queues 304. The queues 204 may indicate the SQ 109 and the CQ 110 at a first time. The queues 304 may indicate the SQ 109 and the CQ 110 at a second time. The second time may be subsequent to the first time.

During operation, the SQ/CQ availability logic 190 may determine that the SQ 109 is non-empty, as described with reference to FIG. 1. For example, the SQ/CQ availability logic 190 may determine that the SQ 109 is non-empty in response to determining that a first SQ index (e.g., 2) indicated by the SQ head PR 125 is distinct from a second SQ index (e.g., 4) indicated by the SQ tail DBR 115.

The SQ/CQ availability logic 190 may determine that the CQ 110 is full (or that no entries are available) based on the CQ info 155 and the CQ head DBR 116, as described with reference to FIG. 1. For example, the CQ info 155 may indicate a particular CQ slot of the CQ 110 corresponding to a particular CQ index (e.g., 7). The SQ/CQ availability logic 190 may determine that the CQ 110 is full (or that no entries are available) in response to determining that incrementing the CQ info 155 to reserve another CQ slot would cause the CQ info 155 to point to the same slot as the CQ head DBR 116 (e.g., index 0).

The SQ/CQ availability logic 190 may mask the SQ 109 in response to determining that the CQ 110 has no available entries, as described with reference to FIG. 1. For example, the SQ/CQ availability logic 190 may generate the availability data 192 to indicate a subset of the SQs 150, and the SQ 109 may not be included in the subset. In a particular aspect, the subset may include one or more other SQs of the SQs 150, and the SQ/CQ availability logic 190 may access a SQ entry from a particular SQ of the one or more other SQs. In an alternate aspect, the subset may be empty and the SQ/CQ availability logic 190 may access no SQ entries until a next SQ update phase. The queues 304 may indicate the SQ 109 and the CQ 110 subsequent to determining that the CQ 110 is full. The SQ 109 and the CQ 110 may be unchanged at the second time relative to the first time.

The SQ/CQ availability logic 190 may thus determine that the CQ 110 is full based on reserved slots, in addition to slots being used to store pending CQ entries. Determining whether the CQ 110 is full based on reserved slots may prevent a SQ entry of the SQ 109 from being accessed when it is likely that there will be no available slots of the CQ 110 to store a corresponding CQ entry.

Referring to FIG. 4, a diagram is shown and generally designated 400. The diagram 400 includes the queues 304 and queues 404. The queues 304 may indicate the SQ 109 and the CQ 110 at a first time. The queues 404 may indicate the SQ 109 and the CQ 110 at a second time. The second time may be subsequent to the first time.

During operation, the SQ/CQ availability logic 190 may generate the CQ entry 162 in response to detecting that a particular command corresponding to the SQ entry 160 has been completed, as described with reference to FIG. 1. The CQ entry 162 may indicate a value of the SQ head PR 125 indicating a particular index (e.g., index 2) of the SQ 109. The CQ entry 162 may indicate the SQ 109, the SQ entry 160 of FIGS. 1-2, or both. The SQ/CQ availability logic 190 may add the CQ entry 162 to the CQ 110. For example, at the first time, the CQ tail PR 126 may indicate a particular CQ slot of the CQ 110 corresponding to a particular CQ index (e.g., 6). The SQ/CQ availability logic 190 may add the CQ entry 162 at the particular CQ slot of the CQ 110. For example, the SQ/CQ availability logic 190 may add the CQ entry 162 to the slot of the CQ 110 that was reserved in response to accessing the SQ entry 160. The SQ/CQ availability logic 190 may update (e.g., increment) the CQ tail PR 126 to indicate a next CQ slot (e.g., index 7) of the CQ 110 that is logically after and logically next to the particular CQ slot. In a particular aspect, an updated value of the CQ tail PR 126 may be the same as a value of the CQ info 155. The SQ/CQ availability logic 190 may, in response to adding the CQ entry 162 to the CQ 110, send an interrupt via the interconnect 120 of FIG. 1 to the access device 130. The processor 111 may, in response to receiving the interrupt, update the CQ tail ptr 145, as described with reference to FIG. 1. The processor 111 may, in response to receiving the interrupt, determine that the CQ entry 162 has been added to the CQ 110. The processor 111 may, in response to determining that the CQ entry 162 indicates a particular index (e.g., the index 2) of the SQ 109 as an updated value of the SQ head PR 125, update the SQ head ptr 140 to indicate the particular index (e.g., the index 2). Subsequent to the update of the SQ head ptr 140, the SQ head ptr 140 may indicate the same slot as the SQ head PR 125. The queues 404 may indicate the SQ 109 and the CQ 110 subsequent to the update of the CQ tail PR 126, the CQ tail ptr 145, the SQ head ptr 140, or a combination thereof.

Referring to FIG. 5, a diagram is shown and generally designated 500. The diagram 500 includes the queues 404 and queues 504. The queues 404 may indicate the SQ 109 and the CQ 110 at a first time. The queues 504 may indicate the SQ 109 and the CQ 110 at a second time. The second time may be subsequent to the first time.

During operation, the processor 111 of the access device 130 may determine that the CQ head ptr 144 indicates a particular CQ slot of the CQ 110 corresponding to a particular CQ index (e.g., 0). The processor 111 may access the CQ entry 262 from the particular CQ slot. The processor 111 may process the CQ entry 262, as described with reference to FIG. 1.

The processor 111 may, in response to accessing the CQ entry 262, update (e.g., increment) the CQ head ptr 144 to indicate a second CQ slot of the CQ 110. The second CQ slot may be logically next to and logically after the particular CQ slot. The second CQ slot may correspond to a second CQ index (e.g., 1). Subsequent to the update of the CQ head ptr 144, the particular CQ slot may be available to store a CQ entry. The processor 111 may update, via the interconnect 120 of FIG. 1, the CQ head doorbell register 116 to indicate the updated value of the CQ head ptr 144.

Referring to FIG. 6, a diagram is shown and generally designated 600. The diagram 600 includes the queues 504 and queues 604. The queues 504 may indicate the SQ 109 and the CQ 110 at a first time. The queues 604 may indicate the SQ 109 and the CQ 110 at a second time.

During operation, the SQ/CQ availability logic 190 may determine that the SQ 109 is non-empty, as described with reference to FIG. 1. For example, the SQ/CQ availability logic 190 may determine that the SQ 109 is non-empty in response to determining that a first SQ index (e.g., 2) indicated by the SQ head PR 125 is distinct from the second SQ index (e.g., 4) indicated by the SQ tail ptr 141.

The SQ/CQ availability logic 190 may determine that the CQ 110 is not full in response to determining that the CQ 110 includes at least one available slot based on the CQ info 155 and the CQ head DBR 116, as described with reference to FIG. 1. For example, the CQ info 155 may indicate a first CQ slot of the CQ 110 corresponding to a first CQ index (e.g., 7). The SQ/CQ availability logic 190 may generate a next queue tail ptr indicating a second CQ slot that is logically next to and logically after the first CQ slot. The second CQ slot may correspond to a second CQ index (e.g., 0). The SQ/CQ availability logic 190 may determine that the CQ 110 is not full in response to determining that a value (e.g., 0) of the next queue tail ptr is distinct from a value (e.g., 1) of the CQ head DBR 116.

The SQ/CQ availability logic 190 may, in response to determining that the SQ 109 is non-empty and that the CQ 110 is not full, generate the availability data 192 of FIG. 1 to indicate the SQ 109. The arbiter 112 may select the SQ 109 based on a selection policy, as described with reference to FIG. 1. For example, the arbiter 112 may provide the SQ indicator 194 of FIG. 1 to the SQ/CQ availability logic 190. The SQ indicator 194 may indicate the SQ 109.

The SQ/CQ availability logic 190 may, in response to determining that the SQ indicator 194 indicates the SQ 109, access the SQ entry 260 from a first SQ slot corresponding to the first SQ index (e.g., 2) indicated by the SQ head PR 125. The SQ/CQ availability logic 190 may, in response to accessing the SQ entry 260, update (e.g., increment) the SQ head PR 125 to indicate a second SQ slot of the SQ 109 corresponding to a second SQ index (e.g., 3).

Prior to accessing the SQ entry 260, the CQ info 155 may indicate the first CQ slot of the CQ 110 corresponding to the first CQ index (e.g., 7). The SQ/CQ availability logic 190 may, in response to accessing the SQ entry 260, update the CQ info 155, to indicate that a slot of the CQ 110 is reserved to store a CQ entry corresponding to the SQ entry 260, as described with reference to FIG. 1. For example, the SQ/CQ availability logic 190 may update (e.g., increment) the CQ info 155 to indicate the second CQ slot of the CQ 110 corresponding to the second CQ index (e.g., 0). The queues 604 may indicate the SQ 109 and the CQ 110 subsequent to the update of the SQ head PR 125 and the CQ info 155.

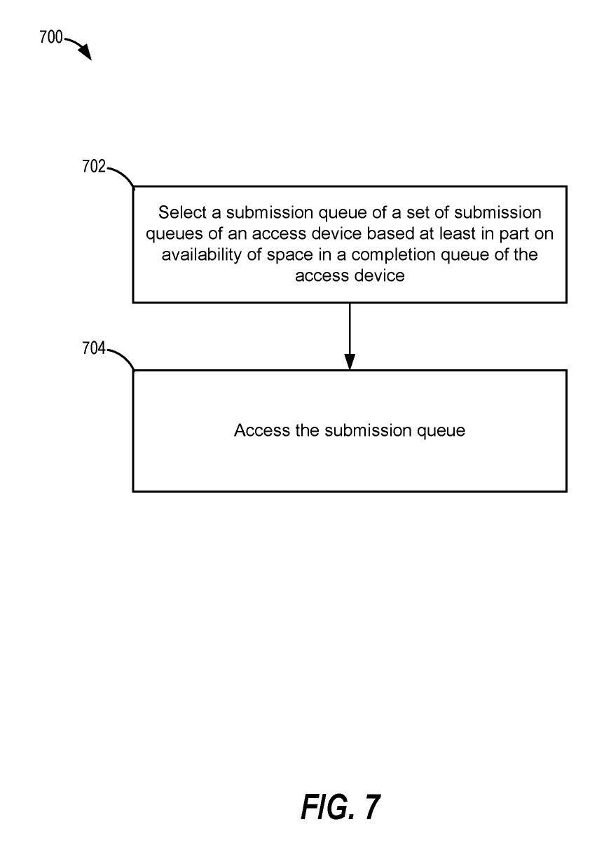

Referring to FIG. 7, a method is shown and generally designated 700. The method 700 may be performed by the SQ/CQ availability logic 190, the SQ filter 105, the controller 102, the data storage device 103, the system 100 of FIG. 1, or a combination thereof.

The method 700 includes selecting a submission queue of a set of submission queues of an access device based at least in part on availability of space in a completion queue of the access device, at 702. For example, the SQ/CQ availability logic 190 of FIG. 1 may select the SQ 109 from a first set of the SQs 150 of the access device 130 based at least in part on availability of space in the CQ 110, as described with reference to FIG. 1. To illustrate, the SQ/CQ availability logic 190 may select the SQ 109 from the SQs 150 in response to determining that the SQ 109 is non-empty and that the CQ 110 has available space, as described with reference to FIG. 1. The SQ/CQ availability logic 190 may generate the availability data 192 indicating a first subset of the SQs 150. The first subset may include the SQ 109. The arbiter 112 may select the SQ 109 from the first subset based on a selection policy and may provide the SQ indicator 194 that indicates the SQ 109 to the SQ/CQ availability logic 190.

The method 700 also includes accessing the submission queue, at 704. For example, the SQ/CQ availability logic 190 of FIG. 1 may access the SQ 109, as described with reference to FIG. 1. To illustrate, the SQ/CQ availability logic 190 may, in response to determining that the SQ indicator 194 indicates the SQ 109, access the SQ entry 160 of the SQ 109, as described with reference to FIG. 1.

The method 700 may thus enable selection of a SQ based on availability of space of a corresponding CQ. A SQ entry of the SQ may be accessed when there is space available in the corresponding CQ to store a corresponding CQ entry. An access of an SQ may be prevented when there is likely to be no space in a corresponding CQ to store a corresponding CQ entry.

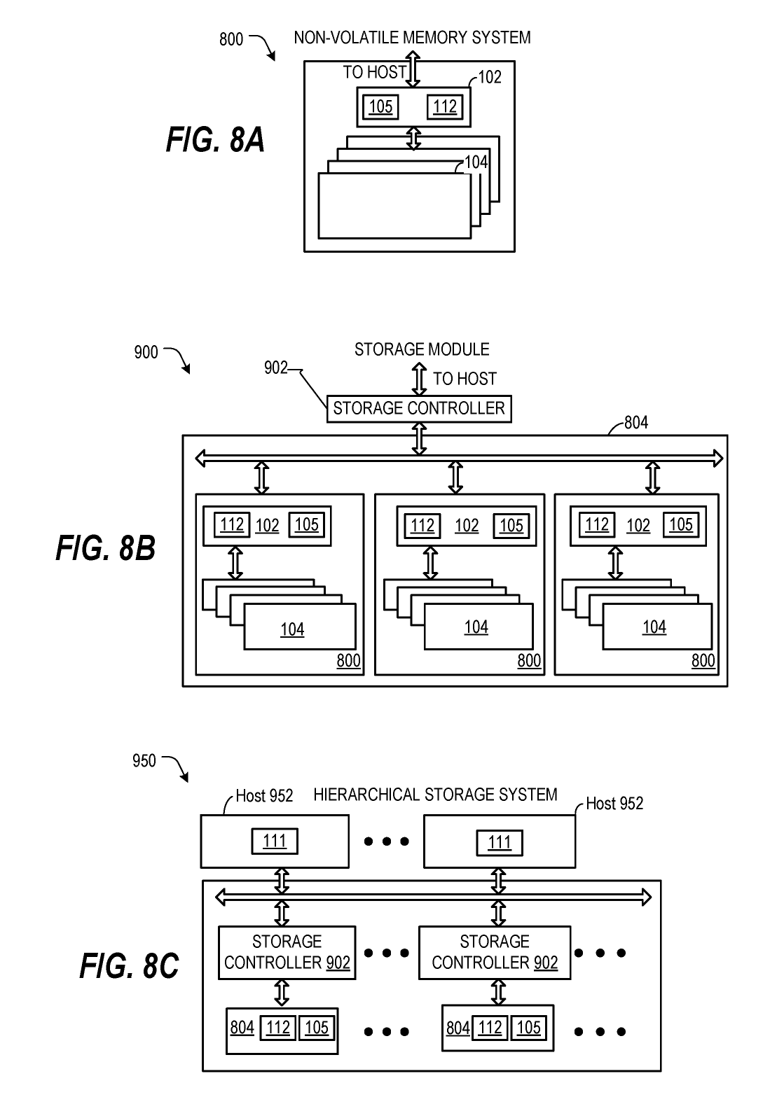

Memory systems suitable for use in implementing aspects of the disclosure are shown in FIGS. 8A-8C. FIG. 8A is a block diagram illustrating a non-volatile memory system according to an example of the subject matter described herein. Referring to FIG. 8A, a non-volatile memory system 800 includes the controller 102 and non-volatile memory that may be made up of one or more non-volatile memory die (e.g., the memory 104). As used herein, the term “memory die” refers to the collection of non-volatile memory cells, and associated circuitry for managing the physical operation of those non-volatile memory cells, that are formed on a single semiconductor substrate. The controller 102 interfaces with a host system and transmits command sequences for read, program, and erase operations to non-volatile memory die (e.g., the memory 104). The controller 102 may include the SQ filter 105, the arbiter 112, or both.

The controller 102 (which may be a flash memory controller) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory, map out bad flash memory cells, and allocate spare cells to be substituted for future failed cells. Some part of the spare cells can be used to hold firmware to operate the flash memory controller and implement other features. In operation, when a host is to read data from or write data to the flash memory, the host communicates with the flash memory controller. If the host provides a logical address to which data is to be read/written, the flash memory controller can convert the logical address received from the host to a physical address in the flash memory. (Alternatively, the host can provide the physical address.) The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die (e.g., the memory 104) may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between the controller 102 and the non-volatile memory die (e.g., the memory 104) may be any suitable flash interface, such as Toggle Mode 200, 400, or 800. In one embodiment, the non-volatile memory system 800 may be a USB flash drive or a card based system, such as a secure digital (SD) or a micro secure digital (micro-SD) card. In an alternate embodiment, memory system 800 may be part of an embedded memory system.

Although, in the example illustrated in FIG. 8A, the non-volatile memory system 800 (sometimes referred to herein as a storage module) includes a single channel between the controller 102 and the non-volatile memory die (e.g., the memory 104), the subject matter described herein is not limited to having a single memory channel. For example, in some NAND memory system architectures (such as the ones shown in FIGS. 8B and 8C), 2, 4, 8 or more NAND channels may exist between the controller and the NAND memory device, depending on controller capabilities. In any of the embodiments described herein, more than a single channel may exist between the controller 102 and the non-volatile memory die (e.g., the memory 104), even if a single channel is shown in the drawings.

FIG. 8B illustrates a storage module 900 that includes plural non-volatile memory systems 800. As such, storage module 900 may include a storage controller 902 that interfaces with a host and with storage system 804, which includes a plurality of non-volatile memory systems 800. The interface between the storage controller 902 and non-volatile memory systems 800 may be a bus interface, such as a serial advanced technology attachment (SATA) or peripheral component interface express (PCIe) interface. Storage module 900, in one embodiment, may be a solid state drive (SSD), such as found in portable computing devices, such as laptop computers, and tablet computers. Each controller 102 of FIG. 8B may include the SQ filter 105, the arbiter 112, or both.

FIG. 8C is a block diagram illustrating a hierarchical storage system. A hierarchical storage system 950 includes a plurality of storage controllers 902, each of which controls a respective storage system 804. Host systems 952 may access memories within the hierarchical storage system 950 via a bus interface. In one embodiment, the bus interface may be an NVMe or fiber channel over Ethernet (FCoE) interface. In one embodiment, the hierarchical storage system 950 illustrated in FIG. 8C may be a rack mountable mass storage system that is accessible by multiple host computers, such as would be found in a data center or other location where mass storage is needed. Each storage system 804 of FIG. 8C may be configured to include the SQ filter 105, the arbiter 112, or both.

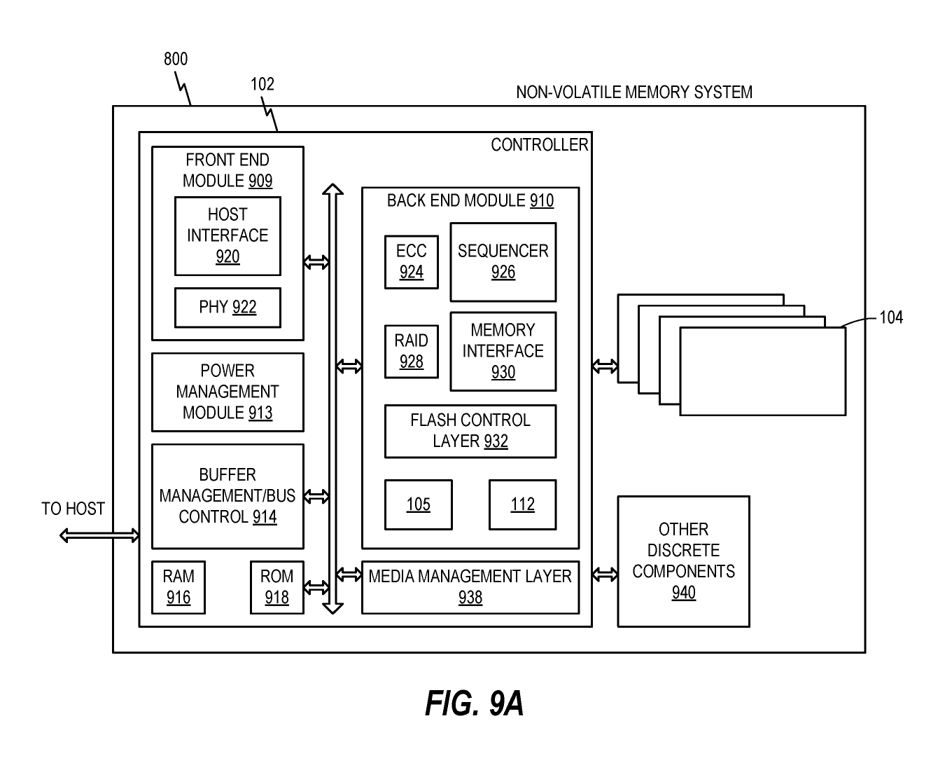

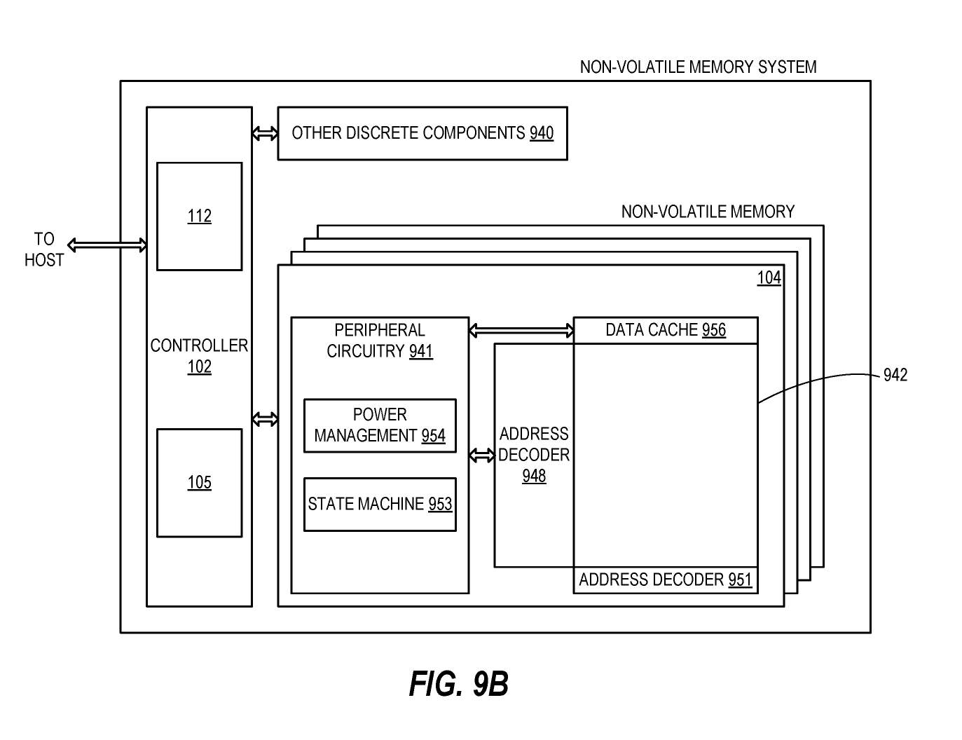

FIG. 9A is a block diagram illustrating exemplary components of the controller 102 in more detail. The controller 102 includes a front end module 909 that interfaces with a host, a back end module 910 that interfaces with the one or more non-volatile memory die (e.g., the memory 104), and various other modules that perform other functions. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Referring again to modules of the controller 102, a buffer manager/bus controller 914 manages buffers in random access memory (RAM) 916 and controls the internal bus arbitration of the controller 102. A read only memory (ROM) 918 stores system boot code. Although illustrated in FIG. 9A as located within the controller 102, in other embodiments one or both of the RAM 916 and the ROM 918 may be located externally to the controller 102. In yet other embodiments, portions of RAM and ROM may be located both within the controller 102 and outside the controller 102.

The front end module 909 includes a host interface 920 and a physical layer interface (PHY) 922 that provide the electrical interface with the host or next level storage controller. The choice of the type of host interface 920 can depend on the type of memory being used. Examples of host interfaces 920 include, but are not limited to, SATA, SATA Express, SAS, Fibre Channel, USB, PCIe, and NVMe. The host interface 920 typically facilitates transfer for data, control signals, and timing signals.

Back end module 910 includes an error correction code (ECC) engine 924 that encodes the data received from the host, and decodes and error corrects the data read from the non-volatile memory. A command sequencer 926 generates command sequences, such as program and erase command sequences, to be transmitted to non-volatile memory die (e.g., the memory 104). A RAID (Redundant Array of Independent Drives) module 928 manages generation of RAID parity and recovery of failed data. The RAID parity may be used as an additional level of integrity protection for the data being written into the non-volatile memory die (e.g., the memory 104). In some cases, the RAID module 928 may be a part of the ECC engine 924. A memory interface 930 provides the command sequences to non-volatile memory die (e.g., the memory 104) and receives status information from non-volatile memory die (e.g., the memory 104). For example, the memory interface 930 may be a double data rate (DDR) interface, such as a Toggle Mode 200, 400, or 800 interface. A flash control layer 932 controls the overall operation of back end module 910. The back end module 910 may also include the SQ filter 105, the arbiter 112, or both.

Additional components of system 800 illustrated in FIG. 9A include a power management module 913 and a media management layer 938, which performs wear leveling of memory cells of non-volatile memory die (e.g., the memory 104). System 800 also includes other discrete components 940, such as external electrical interfaces, external RAM, resistors, capacitors, or other components that may interface with controller 102. In alternative embodiments, one or more of the physical layer interface 923, RAID module 928, media management layer 938 and buffer management/bus controller 914 are optional components that are omitted from the controller 102.

FIG. 9B is a block diagram illustrating exemplary components of non-volatile memory die (e.g., the memory 104) in more detail. Non-volatile memory die (e.g., the memory 104) includes peripheral circuitry 941 and non-volatile memory array 942. The non-volatile memory cells may be any suitable non-volatile memory cells, including NAND flash memory cells and/or NOR flash memory cells in a two dimensional and/or three dimensional configuration. Peripheral circuitry 941 includes a state machine 953 that provides status information to the controller 102, which may include the SQ filter 105, the arbiter 112, or both. The peripheral circuitry 941 may also include a power management or data latch control module 954. Non-volatile memory die (e.g., the memory 104) further includes discrete components 940, an address decoder 948, an address decoder 951, and a data cache 956 that caches data.

Although various components depicted herein are illustrated as block components and described in general terms, such components may include one or more microprocessors, state machines, or other circuits configured to enable the SQ filter 105, the arbiter 112, or both, of FIGS. 1, 8A, 8B, 8C, 9A, and 9B to access a SQ that is selected based at least in part on an availability of space in a corresponding CQ described above with reference to FIGS. 1-7. For example, the SQ filter 105, the arbiter 112, or both, may represent physical components, such as hardware controllers, state machines, logic circuits, or other structures, to cause the SQ filter 105 to access a SQ that is selected based on at least in part on an availability of space in a corresponding CQ (e.g., access the SQ 109 of FIG. 1 that is selected based on an availability of space in the CQ 110 of FIG. 1). The SQ filter 105, the arbiter 112, or both, may be implemented using a microprocessor or microcontroller programmed to access the SQ 109 of FIG. 1 that is selected based on an availability of space in the CQ 110 of FIG. 1.

In a particular embodiment, the data storage device 103 may be implemented in a portable device configured to be selectively coupled to one or more external devices. However, in other embodiments, the data storage device 103 may be attached or embedded within one or more host devices, such as within a housing of a host communication device. For example, the data storage device 103 may be within a packaged apparatus such as a wireless telephone, a personal digital assistant (PDA), a gaming device or console, a portable navigation device, or other device that uses internal non-volatile memory. In a particular embodiment, the data storage device 103 may include a non-volatile memory, such as a three-dimensional (3D) memory, a flash memory (e.g., NAND, NOR, Multi-Level Cell (MLC), a Divided bit-line NOR (DINOR) memory, an AND memory, a high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A data storage device comprising:
a memory; and
a controller coupled to the memory, the controller configured to select a submission queue from a set of submission queues of an access device based at least in part on availability of space in a completion queue of the access device.

2. The data storage device of claim 1, wherein each submission queue of the set of submission queues is non-empty, and wherein the submission queue is selected based on determining that the completion queue is not full.

3. The data storage device of claim 1, wherein the controller is further configured to, subsequent to accessing the submission queue, update completion queue information.

4. The data storage device of claim 3, wherein the controller is further configured to determine that the completion queue has available space based on the completion queue information.

5. The data storage device of claim 3, wherein the controller is further configured to:
determine a next completion queue tail pointer value based on the completion queue information; and
determine that the completion queue has available space based on determining that the next completion queue tail pointer value is distinct from a completion queue head pointer value of the completion queue.

6. The data storage device of claim 3, wherein the controller is configured to update the completion queue information to indicate that a portion of the completion queue is reserved to store a completion queue entry corresponding to a submission queue entry of the submission queue.

7. The data storage device of claim 1, wherein the controller is further configured to, subsequent to performing a command corresponding to a submission queue entry of the submission queue:
add a completion queue entry to the completion queue; and
update a second completion queue tail pointer value of the completion queue.

8. The data storage device of claim 1, wherein the controller includes a submission queue register, and wherein the controller is further configured to select the submission queue in response to detecting an update, from the access device, of the submission queue register.

9. The data storage device of claim 1, wherein the controller includes a completion queue register, and wherein the controller is further configured to select the submission queue in response to detecting an update, from the access device, of the completion queue register.

10. A method performed by a controller of a data storage device, the method comprising:
selecting a submission queue of a set of submission queues of an access device based at least in part on availability of space in a completion queue of the access device; and
accessing the submission queue.

11. The method of claim 10, wherein each submission queue of the set of submission queues is non-empty, and wherein the submission queue is selected based on determining that the completion queue is not full.

12. The method of claim 10, further comprising, in response to accessing the submission queue, updating completion queue information to indicate that a portion of the completion queue is unavailable.

13. The method of claim 12, further comprising determining that the completion queue has available space based on the completion queue information.

14. The method of claim 10, further comprising:
determining a next completion queue tail pointer value based on completion queue information; and
in response to determining that the next completion queue tail pointer value is distinct from a completion queue head pointer value of the completion queue, determining that the completion queue has available space.

15. The method of claim 10, further comprising, subsequent to performing a command corresponding to a submission queue entry of the submission queue:
adding a completion queue entry to the completion queue; and
updating a second completion queue tail pointer value of the completion queue.

16. A device comprising:
a memory; and
a controller coupled to the memory, the controller configured to maintain completion queue information, to determine availability of space of a completion queue of an access device based on the completion queue information, and to select a submission queue from a set of submission queues of the access device based at least in part on the availability of space of the completion queue.

17. The device of claim 16, wherein the controller is further configured to, in response to accessing a submission queue entry of the submission queue, update the completion queue information to indicate that a portion of the completion queue is reserved to store a completion queue entry corresponding to the submission queue entry.

18. The device of claim 16, wherein the controller is further configured to, in response to performing a command corresponding to a submission queue entry of the submission queue, add a completion queue entry to the completion queue.

19. The device of claim 16, further comprising:
a submission queue filter configured to select a subset of submission queues from the set of submission queues in response to determining that each submission queue of the subset of submission queues has a corresponding completion queue that is not full; and
an arbiter configured to, in response to receiving availability data from the submission queue filter indicating the subset of submission queues, select the submission queue from the subset of submission queues based on a selection policy.

20. The device of claim 19, wherein the selection policy includes at least one of a round robin selection policy, a weighted round robin selection policy, a priority-based selection policy, or a combination thereof.
